(19) United States
(12) Patent Application Publication
(10) Pub. No.: US 2022/0339828 A1
(43) Pub. Date: Oct. 27, 2022

(54) METHOD FOR MANUFACTURING A FOAMED PLASTIC MOLDED BODY WITH A FILM LAYER COATING

(71) Applicants: Thorsten MICHEL, Lautert (DE); KANEKA BELGIUM NV, Westerlo-Oevel (BE)

(72) Inventors: Thorsten MICHEL, Lautert (DE); Patrick NAEGELS, Westerlo-Oevel (BE)

(73) Assignees: Thorsten MICHEL, Lautert (DE); KANEKA BELGIUM NV, Westerlo-Oevel (BE)

(21) Appl. No.: 17/764,306

(22) PCT Filed: Oct. 13, 2020
(86) PCT No.: PCT/EP2020/078784

§ 371 Date: Mar. 28, 2022

(30) Foreign Application Priority Data
Oct. 15, 2019 (DE) 10 2019 127 756.6

(51) Int. Cl. B29C 44/06; B29C 44/44; B29C 44/34

(52) U.S. Cl. CPC B29C 44/06; B29C 44/445; B29C 44/3415; B29K 2101/12

(57) ABSTRACT

A method for manufacturing a foamed plastic molded body with a film layer coating by using a tool mold with at least one tool cavity to form a shaping mold cavity, including A) heating at least one tool cavity of the tool mold; B) applying a granulate to the at least one heated tool cavity; C) fusing the granulate in the heated tool cavity to form a liquid film layer; D) applying the liquid film layer to a foamed plastic molded body to form a film layer coating on the surface of the plastic molded body by fusing the liquid film layer with the surface of the plastic molded body; and E) cooling the at least one tool cavity and ejecting the plastic molded body coated with the film layer.

### FIELD

The invention relates to a method for manufacturing a foamed plastic molded body with a film layer coating by using a tool mold with at least one tool cavity to form a shaping mold cavity.

### BACKGROUND

Manufacturing methods as well as a one-part or multi-part tool mold for manufacturing a molded body of foamed plastic are know from prior art. In the known methods, the mold cavity is filled with expandable particles and/or foam pearls in the one-part or multi-part tool mold comprising at least one tool cavity to form a shaping mold cavity, and a pressurized steam flows therethrough having such temperatures and humidity that the particles and/or foam pearls expand and weld together in the mold cavity (said method is also known as steam chamber method). It is also known from prior art to heat the shaping mold cavity through two opposite tool halves and the insides of the mold cavities and to then fill the expandable particles and/or foam pearls into the mold cavity which absorb the heat energy through the heated mold cavities and expand in the mold cavity and fuse with each other while forming a foamed plastic molded body. The mold cavity, which is defined by the at least one tool cavity of the tool mold, is decisive for the geometry of the foamed plastic molded body to be manufactured. After cooling, the plastic molded body manufactured in the tool mold can be ejected or demolded from the tool mold by opening the tool mold.

Such a device as well as a method for manufacturing a foamed plastic molded body have become known from DE 10 2009 006 507 B3, for example.

The foamed plastic molded bodies previously known from prior art do not have a closed or continuous surface after completion of the manufacturing process described above. The expansion method rather leaves microcavities on the surface of the foamed plastic molded bodies, into which fluids can enter, for example. It is also disadvantageous that the plastic molded bodies do not have a closed plane surface structure due to the aforementioned cavities and are thus not directly suitable for a lacquering of the molded body in order to be used in automotive engineering, for example.

Moreover, the previously known foamed plastic molded bodies only have the color of the expanded or the foamed plastic granulate, respectively, which is used as the source material. For specific areas of application, for example in the food industry, but also for the area of automotive engineering, it is a requirement to manufacture the foamed plastic molded bodies with a closed surface having a low degree of roughness in order to be able to directly lacquer the molded bodies and to use them as a bumper in a motor vehicle, for example.

It is already know from prior art to coat the aforementioned foamed plastic molded bodies by means of additional film layers in order to obtain a closed and plane surface for the fabric molded body, wherein it is a disadvantage in the previous manufacturing methods that the aforementioned plastic films have to be applied to the foamed plastic molded bodies in a separate working step.

### SUMMARY

Based on the above mentioned prior art, it is an object of the present invention to propose a simplified manufacturing method for manufacturing a foamed plastic molded body with a film layer coating, which is more cost-effective and can be carried out with a reduced manufacturing time and with which furthermore the properties of the plastic molded body can be specifically adjusted to the intended purpose of application.

According to the invention, the object of the present invention is achieved by a manufacturing method for manufacturing a foamed plastic molded body with a film layer coating by using a tool mold with at least one tool cavity to form a shaping mold cavity, the method comprising the following method steps:

A) heating at least one tool cavity of the tool mold;

B) applying a granulate to the at least one heated tool cavity;

C) fusing the granulate in the heated tool cavity to form a liquid film layer;

D) applying the liquid film layer to a foamed plastic molded body to form a film layer coating on the surface of the plastic molded body by fusing the liquid film layer with the surface of the plastic molded body; and

E) cooling the tool cavity and ejecting the plastic molded body coated with the film layer.

In method step E), the tool mold and in particular the heated at least one tool cavity of the tool mold is cooled down to the demolding temperature and then the plastic molded body with film layer coating is ejected or demolded from the tool mold as a component falling out as a tool. The granulate applied in method step B) is the desired material out of which the film layer coating to be formed is formed for the foamed plastic molded body. In method step A), the heating of the at least one tool cavity to at least the melting temperature of the granulate applied in method step B) is performed in order to form a liquid film layer of method step C) which is formed of the melted out granulate. While performing the method, the temperature of the at least one tool cavity can be guided or controlled, respectively, in such a way that the temperature is substantially at least above the melting temperature of the applied granulate during the entire period of performing at least method steps B) to D).

The method according to the invention has the advantage that a closed film layer coating can be produced on the plastic molded body by using the already existing tools, in particular the multi-part tool molds. Meanwhile, the additional devices which were previously required according to prior art for the application of particularly a plastic film layer or textile layers with a plastic layer in order to realize a coating on the plastic molded body become obsolete. It is particularly advantageous in the method according to the invention that said method can be integrated smoothly into the already existing production process of the manufacturing method or can be directly connected thereto which results in a significant saving of time and an increase in effectiveness, respectively. By fusing the granulate in method step C), a continuous film layer of the granulate material with a defined film layer thickness is formed in the heated tool cavity, wherein the continuous film layer is in a fused or liquid state in the heated tool cavity after completion of method step C). In method step D), the fused film layer is applied in the liquid state to the foamed plastic molded body at least proportionately to its surface in order to form a closed film layer coating on the surface of the plastic molded body and directly fuses or solidifies, respectively, on the previous surface of the plastic molded body. The film layer can cover the entire surface of the foamed plastic molded body or alternatively only partial surface subregions of the plastic molded body as a closed film layer. The method according to the invention also has the advantage that no burrs occur on the manufactured plastic molded body which is why no reworking of the manufactured finished parts is required, for example to remove a sprue or a protruding burr.

According to the invention, it may be provided that prior to performing method steps A) to E), the actual plastic molded body is initially manufactured in the tool mold by a foaming or expansion method, as it is know from prior art, then the tool mold is opened, wherein the foamed plastic molded body remains it at least one tool cavity and method steps A) to E) are then performed for at least one second opposite tool cavity, wherein applying the film layer according to method step D) is performed by closing the tool mold again around the already expanded plastic molded body and the cooling in method step E) of the at least one tool cavity is performed in the closed molding condition. The aforementioned embodiment of the manufacturing method according to the invention has the advantage that the production of the film layer coating is realized directly after the method already known from prior art for manufacturing foamed plastic molded bodies using the known expansion methods, and wherein the application of the film layer by using the already existing tool mold is possible according to the invention. Due to the production and application of the film layer directly after manufacturing the plastic molded body, a good bonding or adhesion of the film layer on the plastic molded body can be realized since intermediate contamination of the bonding surface of the plastic molded body is avoided.

The plastic molded body can be manufactured by means of an expansion method in the cavity of the tool mold by using all foamable particle foams such as EPS (expandable polystyrol), EPP (expandable polypropylene), EPE (expandable polyethylene), expandable thermoplastic polyurethane (E-TPU) and polystyrol containing graphite or carbon. In an alternative embodiment of the manufacturing method, it may also be provided to manufacture the plastic molded body by means of an expansion method in a first tool mold and to then perform the method steps according to the invention in a second tool mold.

In a further preferred embodiment of the manufacturing method according to the invention it may be provided that in the area of the at least one tool cavity first method steps A) to C) are performed, then the tool mold is closed and the mold cavity of the tool mold is filled with a first expandable plastic granulate or with foam pearls, respectively, and then the first expandable plastic granulate or the foam pearls, respectively, are expanded in the mold cavity, wherein method step D) is performed by the fact that the plastic molded body is expanded against the liquid film layer formed on the at least one tool cavity and directly fuses therewith.

Particularly preferred it may be provided that the expansion process of the first expandable plastic granulate is cancelled early or stopped early after a defined period of time, which is why only a proportion of the plastic granulate or the foam pearls, respectively, is expanded. The proportion of the first plastic granulate which has not yet melted or expanded is then removed from the mold cavity so that only a layer of the first expanded plastic granulate adheres to the film layer. The obtained interim article can remain in the mold cavity or can be demolded from the mold cavity in order to perform further processing steps.

Preferably, when the interim article remains in the mold cavity, after removing the non-expanded proportion of the first plastic granulate, the mold cavity can be filled with a second expandable plastic granulate or with foam pearls, respectively, which are then expanded to form the plastic molded body. The described method can be used to manufacture a plastic molded body having a film layer, wherein below said film layer is a layer of first expanded plastic particles or foam pearls, respectively, of a first material, which is fused with the film layer or bonded thereto, and below said layer is a second layer of second expanded plastic particles or plastic pearls, respectively, which is formed of a second material and which is at least connected to the first layer or bonded thereto, respectively. The described method makes it possible to manufacture a plastic molded body consisting of two different foamed granulates.

Preferably, at least two different expandable plastic granulates with different material properties are used for the manufacturing process. In a first exemplary embodiment, the first expandable plastic granulate can be selected such that it results in a local foam body with a low density and at the same time high elasticity, and the second granulate results in a local foam body with a higher density and lower elasticity compared to the first expandable plastic granulate. As a consequence, a resulting foamed plastic molded body can be obtained which has a soft and flexible surface below the film layer coating in the area of the surface, wherein the lower local foam area is structurally stable and non-deformable.

In an alternative embodiment, the first expandable plastic granulate can have a higher stiffness and a higher density than the second expandable plastic granulate such that an article with a very stiff surface and at the same time reduced weight can be obtained. The advantage of providing a first foam layer formed of an expandable plastic granulate with a high stiffness and at the same time high density is that film layer coatings with a low film thickness can be realized.

By specifically selecting the first and second expandable plastic granulates, the resulting local properties of the foam layers forming the plastic molded body can be specifically influenced. Moreover, it may be provided that by repeating the method more than two different expandable plastic granulates are used to form the plastic molded body. Accordingly, it may be provided in a preferred embodiment that when leaving the interim article in the mold cavity after removing a non-expanded proportion of the first plastic granulate, the mold cavity is filled with at least two further expandable plastic granulates or plastic pearls, respectively, which are then expanded in order to form the plastic molded body. In doing so, the expansion process of the further expandable plastic granulate is cancelled early or stopped early after a defined period of time which is why only a proportion of the further plastic granulate or plastic pearls, respectively, is expanded. The proportion of the further plastic granulate that is not yet melted or expanded can then be removed from the mold cavity so that layers with defined thicknesses of the further expanded plastic granulates can be produced. The described method enables manufacturing a plastic molded body having a film layer, wherein below said film layer is a layer of first expanded plastic particles or plastic pearls, respectively, of a first material, which is fused with the film layer or bonded thereto, and below said layer is an arbitrary number of further layers of further expanded plastic particles or plastic pearls, respectively, of further materials, which are at least connected to the first layer or bonded thereto, respectively. The described method makes it possible to manufacture a plastic molded body with a film layer and an arbitrary number of underlying layers of expanded plastic particles. Consequently, a so-called multilayer molded body with 3 to 6 layers in particular can be produced.

It may also be provided that the granulate is applied in method step B) beyond the region of the at least one tool cavity to the surface of the multi-part tool mold, and that at least one part of the multi-part tool mold comprises a sealing ring which, when closing the tool mold, throws up the granulate outside the region of the at least one tool cavity to a bead in the edge area of the at least one first and/or second tool cavity. The sealing ring is disposed at a first part of the tool mold and, when closing the tool mold, sweeps over the surrounding area of the opposite tool cavity of the at least one second part of the tool mold. During the above-mentioned sweeping, the granulate applied outside the tool cavity is pushed together in the fused condition by the movement of the sealing ring relative to the opposite tool cavity and forms a bead which limits the opposite tool cavity. Thus, when applying a film layer coating, a visible edge at the end of the film layer coating is only avoided on a proportionate surface of the plastic molded body. Furthermore, the circumferential edge of the film layer coating is better bonded to the foam body by means of the bead such that a detachment in the edge areas of the film layer coating can be avoided. It is particularly preferred that the tool mold opposite the sealing ring is designed to be conical such that the sealing ring can be better inserted into the opposite tool mold.

Preferably, it may also be provided according to the invention that the granulate for the film layer coating is applied in method step B) by means of a spray pistol to the at least one tool cavity.

According to a further preferred embodiment of the manufacturing process according to the invention, it may be provided that the at least one tool cavity to be heated is heated in method step A) by introducing a heating medium through corresponding heating channels in the at least one tool cavity. As a heating medium for example heated oil, water or a steam mixture can be supplied.

Alternatively, the at least one tool cavity can be heated by at least one active heating device, e.g. an electric heating element, such as a resistance heating element, a resistor element or an inductive heating element.

Preferably, it may also be provided to directly heat the at least one tool cavity with an external heating source, such as a heated air flow.

According to a further embodiment, the at least one tool cavity can be heated by a radiant heater, such as an infrared radiator, or alternatively by at least one heating burner.

It may also be provided that in method step A) the at least one tool cavity to be heated is heated to at least a temperature above the melting temperature of the applied granulate, in particular to a temperature in the range of 80° C. to 260° C.

According to a preferred embodiment, it may be provided that in method step B) a powdery thermoplastic plastic granulate is applied to the at least one tool cavity. The thermoplastic plastic granulate can be fused by heating the tool cavity so that the tool cavity includes a continuous fused layer of the thermoplastic plastic.

The granulates can also be mixed with additives and applied into the at least one tool cavity. In particular glass fibers and/or carbon fibers could be used as granulated additives.

According to the invention, it may be provided that during or after performing method step C), at least in partial areas of the surface of the at least one tool cavity, a layer of a nonwoven or a textile, such as a woven or knitted fabric, is placed and preferably embedded in or soaked by the liquid film layer. Particularly preferred, the placed layers can comprise defined external contours and dimensions.

Particularly preferred, a thermoplastic plastic granulate with a defined RAL color can be applied to the at least one tool cavity so that a film coating can be produced in a desired defined RAL color. Moreover, plastic granulates with particular properties can be used, such as dissipative properties, flame resistance, suitability for food products, resistance to UV radiation, resistance to heat, increased waterproofness, increased dielectric strength and increased abrasion resistance. Furthermore, a plastic can be used for the film layer coating which forms a substance-to-substance bond with the plastic molded body. This makes it possible to continue to specifically design the plastic molded body with desired properties.

According to the invention, it may also be provided that the plastic molded body and the film layer coating with the same thermoplastic plastic are used in order to realize a mono-material composite, for example a combination of the plastics PP with EPP or PS with EPS can be used. Due to the mono-material composite, the manufactured plastic molded body with film layer coating can be recycled better because of the uniform material.

Moreover, according to the invention, at least one tool cavity with a defined surface texture can be used, which causes a defined surface characteristic of the film layer. For example, the surface of the film layer coating can be provided with defined textures, extremely smooth or rough surfaces with defined roughnesses or hook-and-loop surfaces.

According to a particularly preferred embodiment of the manufacturing method according to the invention, it may be provided that in method step B) a powdery polypropylene (PP) is applied to the at least one tool cavity.

According to a further particularly preferred embodiment, it may be provided that in method step B) granulate is only proportionately applied to defined subregions of the at least one tool cavity to form at least one film layer in certain areas, wherein particularly subregions of the at least one tool cavity can be covered in order to prevent a granulate application in method step B).

Preferably, it may also be provided that the granulate is applied with defined different layer thicknesses in different subregions of the tool cavity such that a film layer coating with locally different film layer thicknesses can be produced on the foamed plastic molded body. The aforementioned method makes it possible for the first time to specifically realize surface areas with different strengths and also bending stiffnesses in the film layer coating. In particular, it is made possible to introduce weakened areas in the surface, which, for example when using the plastic molded body in the automotive sector, cause a defined deformation behavior, for example in case of an impact.

In particular, it may be provided that in method step B) a granulate is applied to the tool cavity with a layer thickness in the range of 0.05 mm to 2 mm. The layer thickness of the granulate can be selected depending on the underlying expanded plastic granulate.

According to a further preferred embodiment, it may be provided that in method step E) the at least one tool cavity to be cooled is cooled convectively and/or conductively.

According to a particularly preferred embodiment, it may be provided that in method step E) the at least one tool cavity to be cooled is cooled by the fact that a cooling medium is conduced through channels of the at least one tool cavity. The supplied cooling medium can be a cooling fluid, in particular oil, cooling air or cooling water, for example.

Alternatively, it may be provided that in method step E) the at least one tool cavity to be cooled is cooled by spraying a cooling medium on at least one tool cavity to be cooled through at least one nozzle device, in particular, it may be provided that water in a liquid condition is sprayed on the at least one tool cavity to be cooled through a plurality of nozzle device, in particular atomizing nozzles.

According to the invention, it may further be provided that the temperature of the at least one tool cavity to be heated in method step A) is monitored by means of a temperature sensor. Preferably, by means of the temperature sensor, the desired process temperatures can also be monitored during the entire manufacturing method or in defined method steps and can be controlled specifically depending on the measured values.

It may also be provided that the supply of heating medium or alternatively the electrical nozzle device can be controlled with the temperature sensor.

In particular, it may be provided that for manufacturing the foamed plastic molded body after performing method steps A) to C), at least one particle foam granulate is supplied into the closed tool mold through at least one injector device. The tool mold can also be filled locally with different expandable plastic granulates through several injector devices.

Furthermore, it may be provided according to the invention that method steps A) to C) are performed on at least one external tool cavity which is brought together with the tool mold by a displacement in method steps D) and E) to form the mold cavity. For example, a rotary disc tool with a plurality of tool cavities can be used according to the invention.

In the following, some examples of the manufacturing method according to the invention are described.

### Examples 1, 2 and 3

A square tool with the dimensions 370×370×60 mm was used for manufacturing plates according to the steam chamber method based on EPP—expanded polypropylene foam particles (trademark Eperan-PP VB45, M30 and VB15 by Kaneka Belgium N.V.). The plates were stabilized in an oven at 80° C. for 24 hours and stored at ambient conditions (23° C.-50% relative humidity). A circular heating plate was electrically heated to a temperature of 220° C., a granulate (polypropylene “Gray EX1Y 1876” by Axalta Coating Systems GmbH) was sprayed on the heated plate and fused therewith. The EPP plate was pressed on the layer of melted granulate, the plate was cooled by air and as a result a film-coated foamed plastic part was obtained.

### Examples 4 and 5

A cavity of a tool for manufacturing bowls (example 4) and a cavity of a tool for manufacturing an A-pillar trim for vehicles (example 5) were heated to 185° C. or 180° C., respectively, by using the Variotherm technology. The Variotherm technology is a heating and cooling system with which the temperature in all areas of a tool can be precisely controlled. The tool cavity does not necessarily have to be integrated into the steam chamber of the molding machine. A granulate (polypropylene “Black EX1Y 1886” or “EX1Y 1886 Blue 565” by Axalta Coating Systems GmbH) was sprayed on the heated cavity and fused therewith. The tool was closed and the cavity was filled with EPP—expanded polypropylene foam particles (trademark “Eperan-PP MN20” and “Eperan-PP VB 20” by Kaneka Belgium N.V.)—and the steam chamber method was applied. In both cases, a foamed plastic part could be manufactured which was partially covered 100% with a film layer in the desired areas.

### Examples 6, 7, 8, 9, 10 and 11

Tools for manufacturing a bowl (example 6, 7) and an A-pillar trim for vehicles (examples 8, 9, 10, 11) were used for manufacturing a foamed plastic part according to the steam chamber method based on EPP—foam particles of expanded polypropylene (trademark Eperan-PP VB30, VB20, M30 and MN20 by Kaneka Belgium N.V.). However, at the end of the cycle, the part was not ejected but remained in the cavity. The other cavity was heated to 180 to 185° C. by using the Variotherm technology. A granulate (polypropylene “Black EX1Y 1886” and “EX1Y 1886 Blue 565” by Axalta Coating Systems GmbH) was sprayed on the surface of the heated cavity and fused therewith. The tool was closed again and cooled. In both cases, a foamed plastic part could be manufactured which was partially covered 100% with a film layer in the desired areas.

### Examples 12 and 13

An A-pillar trim of a vehicle was manufactured according to the steam chamber method based on EPP—expanded polypropylene foam particles (trademark Eperan-PP VB20 and M30 by Kaneka Belgium N.V.). The A-pillar trim was stabilized in an oven at 80° C. for 24 hours and stored at ambient conditions (23° C.-50% relative humidity). A cavity of the A-pillar trim was heated to 180° C. by using the Variotherm technology, a granulate (polypropylene “Black EX1Y 1886” by Axalta GmbH) was sprayed on the heated cavity and fused therewith. The foamed A-pillar trim was pressed on the layer of melted granulate, the plate was cooled and a foamed plastic part with a film coating could be manufactured. This method has proven to be very practical for small series.

### Example 14

The cavity of the A-pillar trim was heated to 180° C. by using the Variotherm technology, a granulate (polypropylene “Black EX1Y 1886” by Axalta Coating Systems GmbH) was sprayed on the heated cavity and fused therewith. The tool with the hot cavity was closed and expanded polypropylene foam particles (trademark Eperan-PP M30 by Kaneka Belgium N.V.) of type X were filled into the tool which then partially adhered to the melted film layer and formed a first layer with a low density (soft). The non-adherent, excessive foam particles were sucked out of the cavity. Foam particles of type Y (trademark Eperan-PP VB20 by Kaneka Belgium N.V.) were filled into the tool and the steam chamber method was applied. A foamed plastic part could be manufactured which was partially covered 100% with a film layer in the desired areas. In addition, by using type X and type Y, two layers of different density (soft and hard) could be realized.

### Example 15

The cavity of the A-pillar trim was heated to 180° C. by using the Variotherm technology, a granulate (polypropylene “Black EX1Y 1886” by Axalta Coating Systems GmbH) was sprayed on the heated cavity and fused therewith. The tool with the hot cavity was closed and expanded polypropylene foam particles (trademark Eperan-PP M30 by Kaneka Belgium N.V.) of type X were filled into the tool which then partially adhered to the melted film layer and formed a first layer with a low density (soft). The cavity was cooled. The non-adherent, excessive expanded polypropylene foam particles were sucked out of the cavity and the film layer with the layer formed of adhering foam particles of type X was removed from the tool and stored. At a later stage, the film layer with a fused layer of foam particles was placed back into a tool. Expanded polypropylene particles of type Y (trademark Eperan-PP VB20 by Kaneka Belgium N.V.) were blown into the tool and the steam chamber method was applied. A foamed plastic part could be manufactured which was partially covered 100% with a film layer in the desired areas. In addition, by using type X and type Y, two layers of different density (soft and hard) could be realized.

TABLE 1
Description of examples 1 to 15 and of comparative example 1

| | | Pre- | | Density | | | | Thickness | | |
|---|---|---|---|---|---|---|---|---|---|---|
| | | foamed | | of | Applied | | | range of | Coverage | |
| Exam- | | foam | | molded | heating | Heating | Granulate | film | by film | |
| ple | Form | particle | Method | part | system | temperature | name | coating | coating | Embossing |
| Unit | — | — | Table 2: | g/l | — | ° C. | — | mm | % | — |
| Ex 1 | plate | Eperan- | 3 | 20 | electrically | 220 | EX1Y | 0.45-0.55 | 100 | no unintended |
| | | PP VB45 | | | heated | | 1876 | | | unevenness |
| | | | | | and air- | | grey | | | |
| | | | | | cooled | | | | | |
| | | | | | plate | | | | | |
| Ex 2 | plate | Eperan- | 3 | 45 | electrically | 220 | EX1Y | 0.45-0.55 | 100 | no unintended |
| | | PP M30 | | | heated | | 1876 | | | unevenness |
| | | | | | and air- | | grey | | | |
| | | | | | cooled | | | | | |
| | | | | | plate | | | | | |
| Ex 3 | plate | Eperan- | 3 | 60 | electrically | 220 | EX1Y | 0.45-0.55 | 100 | no unintended |
| | | PP VB15 | | | heated | | 1876 | | | unevenness |
| | | | | | and air- | | grey | | | |
| | | | | | cooled | | | | | |
| | | | | | plate | | | | | |
| Ex 4 | bowl | Eperan- | 1 | 45 | Variotherm | 185 | EX1Y | 0.65-0.85 | 100 | no unintended |
| | | PP MN20 | | | | | 1886 | | | unevenness |
| | | | | | | | black | | | |
| Ex 5 | A- | Eperan- | 1 | 45 | Variotherm | 180 | EX1Y | 0.90-1.10 | 100 | no unintended |
| | pillar | PP VB20 | | | | | 1886 | | | unevenness |
| | | | | | | | Blue | | | |
| | | | | | | | 565 | | | |
| Ex 6 | bowl | Eperan- | 2 | 45 | Variotherm | 185 | EX1Y | 0.65-0.85 | 100 | no unintended |
| | | PP MN20 | | | | | 1886 | | | unevenness |
| | | | | | | | black | | | |
| Ex 7 | bowl | Eperan- | 2 | 30 | Variotherm | 185 | EX1Y | 0.65-0.85 | 100 | no unintended |
| | | PP VB30 | | | | | 1886 | | | unevenness |
| | | | | | | | black | | | |
| Ex 8 | A- | Eperan- | 2 | 30 | Variotherm | 180 | EX1Y | 0.90-1.10 | 100 | no unintended |
| | pillar | PP M30 | | | | | 1886 | | | unevenness |
| | | | | | | | black | | | |
| Ex 9 | A- | Eperan- | 2 | 30 | Variotherm | 180 | EX1Y | 0.90-1.10 | 100 | no unintended |
| | pillar | PP M3 0 | | | | | 1886 | | | unevenness |
| | | | | | | | Blue | | | |
| | | | | | | | 565 | | | |
| Ex 10 | A- | Eperan- | 2 | 45 | Variotherm | 180 | EX1Y | 0.90-1.10 | 100 | no unintended |
| | pillar | PP VB20 | | | | | 1886 | | | unevenness |
| | | | | | | | black | | | |
| Ex 11 | A- | Eperan- | 2 | 45 | Variotherm | 180 | EX1Y | 0.90-1.10 | 100 | no unintended |
| | pillar | PP VB20 | | | | | 1886 | | | unevenness |
| | | | | | | | Blue | | | |
| | | | | | | | 565 | | | |
| Ex 12 | A- | Eperan- | 3 | 30 | Variotherm | 180 | EX1Y | 0.90-1.10 | 100 | no unintended |
| | pillar | PP M30 | | | | | 1886 | | | unevenness |
| | | | | | | | black | | | |
| Ex 13 | A- | Eperan- | 3 | 45 | Variotherm | 180 | EX1Y | 0.90-1.10 | 100 | no unintended |
| | pillar | PP VB20 | | | | | 1886 | | | unevenness |
| | | | | | | | black | | | |
| Ex 14 | A- | Eperan- | 4 | 30 (X) | Variotherm | 180 | EX1Y | 0.90-1.10 | 100 | no unintended |
| | pillar | PP M30 | | 45 (Y) | | | 1886 | | | unevenness |
| | | (X) | | | | | black | | | |
| | | Eperan- | | | | | | | | |
| | | PP VB2 0 | | | | | | | | |
| | | (Y) | | | | | | | | |
| Ex 15 | A- | Eperan- | 5 | 30 (X) | Variotherm | 180 | EX1Y | 0.90-1.10 | 100 | no unintended |
| | pillar | PP M30 | | 45 (Y) | | | 1886 | | | unevenness |
| | | (X) | | | | | black | | | |
| | | Eperan- | | | | | | | | |
| | | PP VB2 0 | | | | | | | | |
| | | (Y) | | | | | | | | |
| Comparative | plate | Eperan- | — | 30 | — | — | — | — | — | presence |
| example | | PP VB30 | | | | | | | | of |
| 1 | | | | | | | | | | microcavities |

TABLE 2
Methods used for samples Ex 1 to Ex 15 to manufacture foamed plastic
parts with a film coating:

| Method | Step 1 | Step 2 | Step 3 | Step 4 | Step 5 | Step 6 | Step 7 | Step 8 | Step 9 |
|---|---|---|---|---|---|---|---|---|---|
| 1 | A: | B + C: | closing | D: | E: | | | | |
| | heating | spraying | tool | applying | cooling | | | | |
| | tool cavity | ⁽²⁾ and | | film | and | | | | |
| | using | fusing | | layer in | ejecting | | | | |
| | Variotherm ⁽¹⁾ | granulate | | the | the | | | | |
| | | | | step | foamed | | | | |
| | | | | steam | plastic | | | | |
| | | | | chamber | part | | | | |
| | | | | method | with | | | | |
| | | | | for | film | | | | |
| | | | | manufacturing | coating | | | | |
| | | | | foamed | | | | | |
| | | | | plastic | | | | | |
| | | | | parts | | | | | |
| 2 | steam | opening | A: | B + C: | D: | E: | | | |
| | chamber | tool | heating | spraying | closing | cooling | | | |
| | method | without | tool | ⁽²⁾ and | tool | and | | | |
| | for manu- | ejecting | cavity | fusing | and | ejecting | | | |
| | facturing | foamed | using | granulate | applying | the | | | |
| | foamed | plastic | Variotherm ⁽¹⁾ | | film | foamed | | | |
| | plastic | part | | | to | plastic | | | |
| | parts | | | | foamed | part | | | |
| | | | | | plastic | with | | | |
| | | | | | part | film | | | |
| | | | | | | coating | | | |
| 3 | steam | stabilizing | storing | A: | B + C: | D: | E: | | |
| | chamber | foamed | foamed | heating | spraying | bonding | cooling | | |
| | method | plastic | plastic | tool cavity | ⁽²⁾ and | the | and | | |
| | for manu- | part in | parts | using | fusing | temporarily | eject- | | |
| | facturing | oven at | | Variotherm ⁽¹⁾ | granulate | stored | ing the | | |
| | foamed | 80° C. | | | | foamed | foamed | | |
| | plastic | | | | | plastic | plastic | | |
| | parts | | | | | part | part | | |
| | | | | | | with | with | | |
| | | | | | | the | film | | |
| | | | | | | melted | coating | | |
| | | | | | | granulate | | | |
| | | | | | | film by | | | |
| | | | | | | pressing | | | |
| 4 | A: | B + C: | closing | filling | sucking | D: | E: | | |
| | heating | spraying | tool | tool with | off | steam | cooling | | |
| | tool cavity | ⁽²⁾ and | | foam | excessive | chamber | and | | |
| | using | fusing | | particles | foam | method | ejecting | | |
| | Variotherm ⁽¹⁾ | granulate | | of type X | particles | for | the | | |
| | | | | | of type X | manufacturing | foamed | | |
| | | | | | (not | foamed | plastic | | |
| | | | | | bonded | plastic | part | | |
| | | | | | to the | parts | with | | |
| | | | | | film) | with | film | | |
| | | | | | | foam | coating | | |
| | | | | | | particles | | | |
| | | | | | | of type Y | | | |
| 5 | A: | B + C: | closing | filling | cooling | storing | placing | D: | E: |
| | heating | spraying | tool | tool with | cavity | film | film | steam | cooling |
| | tool cavity | ⁽²⁾ and | | foam | and | layer | layer | chamber | and |
| | using | fusing | | particles | sucking | with | with | method | ejecting |
| | Variotherm ⁽¹⁾ | granulate | | of | off | fused | fused | for | the |
| | | | | type X | excessive | foam | foam | manu- | foamed |
| | | | | | foam | particles | particles | facturing | plastic |
| | | | | | (not | of type X | of type X | foamed | part |
| | | | | | bonded | | in a tool | plastic | with |
| | | | | | to the | | | parts | film |
| | | | | | film) and | | | with | coating |
| | | | | | removing | | | foam | |
| | | | | | film | | | particles | |
| | | | | | with | | | of | |
| | | | | | foam | | | type Y | |
| | | | | | particles | | | | |
| | | | | | of type X | | | | |
| | | | | | bonded | | | | |
| | | | | | by fusing | | | | |

⁽¹⁾ Variotherm is a heating and cooling system with which the temperature in all areas of a tool can be precisely controlled. The tool cavity does not necessarily have to be integrated into the steam chamber of the molding machine.
⁽²⁾ Spraying system of Nordson Deutschland GmbH: powder is transferred from a storage or feeding container by means of dense-phase-pump technology to a powder spraying pistol (Encore HD system) which applies the powder with or without electrostatic charge.

The granulate can also be fused on a cavity copy, either on the entire surface or on parts of the surface outside the molding machine. This enables shorter cycle times and also the coating of thick foamed plastic parts if steam nozzles are required on all sides.

Evaluation Methods

Density of Foam Part:

The density of the molded part MD (g/l) of the foamed plastic part listed in table 3 was calculated by dividing the weight W1 (g) of the foamed plastic part by the volume V1 (L) of the foamed plastic part: MD=W1/V1 (g/l)

Water Permeability

A 1% water-based soap solution was prepared by adding 25 g of dishwashing detergent (trademark “Dreft-Original” by Procter & Gamble) to 2500 ml water at a temperature of 25° C.

A foam part having the form of a cylindrical bowl has a total volume of 1600 ml. The inner surface of the bowl is coated with a film layer. It has an open diameter D of 190 mm and the thickness of the bottom and the wall is 10 mm. The bowl is stored at ambient conditions (23° C.-50% relative humidity) and the weight W2 (g) of the bowl is measured.

A volume V2 of 800 ml or 800.000 mm³, corresponding to 50% of the total volume of the bowl, of the soap dispersion is poured into the bowl. The water column in the bowl has a height of 28.32 mm=800,000/((n*190²)/4). The bowl is stored at ambient conditions (23° C.-50% relative humidity) for 24 hours.

Then, the remaining soap solution is removed from the bowl, the inner surface of the bowl is dried with a paper towel, and the “wet weight” W3 (g) of the bowl is measured within 5 minutes after removing the soap dispersion.

The water permeability WP is expressed as a percentage of the weight increase of the bowl: WP (%)=(W3−W2)/W2*100

Hardness

The hardness of the foamed plastic part is measured according to ASTM D2240. The result is indicated as “shore A” value.

Color Homogeneity

The color of a foamed plastic part with and without film coating is measured with a device by BYK Gardner with a color ball system being based on the CIElab color system.

The result of a color measurement is expressed as a set of L, a* and b* values.

The L value varies from 0 to 100, from white to black.

The a* value varies from −127 to +127, from green to red.

The b* value varies from −127 to +127, from blue to yellow.

Color measurements are performed and the average L-, a*- and b* values are calculated at five different points of a surface of 20,000 mm².

The color difference between 2 measurements is indicated as A E and is calculated as follows:

ΔE_{ab}*=\sqrt{(L₂*−L₁*)²+(a₂*−a₁*)²+(b₂*−b₁*)²}

For each individual color measurement ΔEᵢ is calculated against the average L, a* and b* values, with i from 1 to 5. Finally, the varying total ΔE is calculated as an average for five ΔEᵢ values.

TABLE 3

| | | Com- | Density | | | |
|---|---|---|---|---|---|---|
| | | position | foamed | Color | Hard- | Water |
| | | foamed | plastic | homo- | ness | permea- |
| | | plastic | part | geneity | (Shore | bility |
| | Granulate | part | (g/l) | (Δ E) | A) | (%) |
| Ex. 7 | black | Eperan-PP | 30 | 0.22 | 97 | 0.0 |
| | EX1Y | VB30 | | | | |
| | 1886 | | | | | |
| Com- | — | Eperan-PP | 45 | 0.77 | 42 | 5.5 |
| parative example | | MN20 | | | | |

### BRIEF DESCRIPTION OF THE FIGURES

In the following, preferred exemplary embodiments of the method according to the invention are explained by reference to the accompanying drawings, in which

FIG. 1 shows a sectional view through a tool mold in a closed state;

FIG. 2 shows a sectional view of a tool cavity according to the invention while applying granulate;

FIG. 3 shows an exemplary embodiment of a tool mold with a foamed plastic mold manufactured according to the invention; and

FIG. 4 shows a further exemplary embodiment of a tool mold with an external heating system.

### DETAILED DESCRIPTION

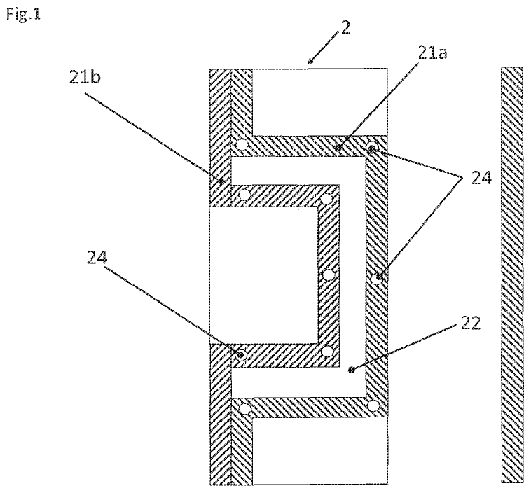

FIG. 1 shows a sectional view of a tool mold 2 in a closed state, wherein the tool mold 2 is formed by two opposite tool cavities 21a and 21b, wherein the aforementioned opposite tool cavities 21a and 21b enclose a shaping mold cavity 22. In the illustrated exemplary embodiment, the first tool cavity 21a is provided with a plurality of heating channels 24 through which a heating medium can be supplied to the first tool cavity 21a so that the first tool cavity 21a can be heated to a defined temperature.

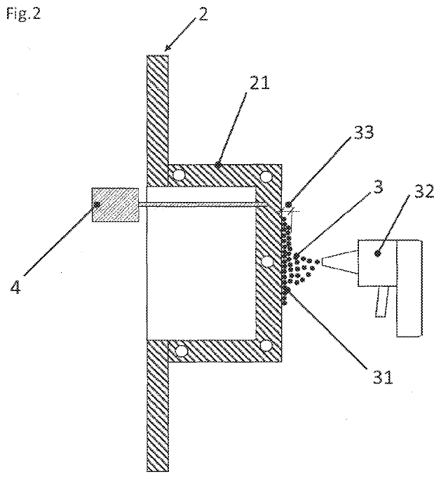

In FIG. 2 an exemplary embodiment of a tool cavity 21 of a tool mold 2 is shown, wherein the illustrated tool cavity comprises a temperature sensor 4 by means of which the temperature of tool cavity 21 can be measured. In FIG. 2 the process of applying granulate 3 by means of a spraying pistol 32 is shown, wherein the applied granulate forms a film layer 31 with a film layer thickness 33 in the area of tool cavity 21. As can also be seen in FIG. 2, layer thicknesses 33 of applied granulate 3 can be adjusted or specifically influenced in sections in tool cavity 21 by specific application of granulate 3 by means of spraying pistol 32.

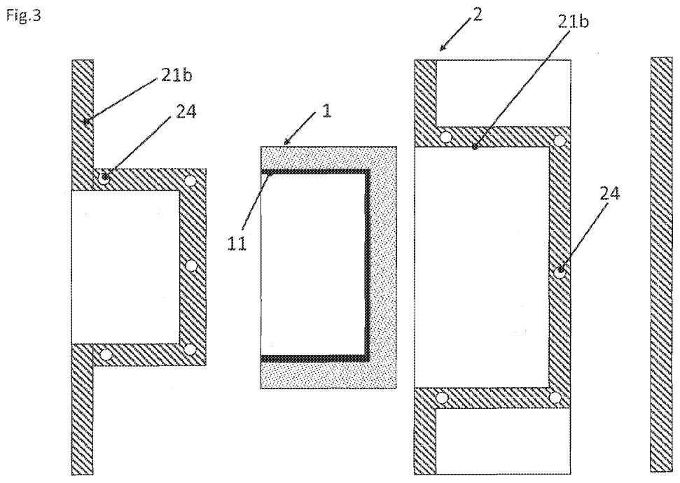

FIG. 3 shows a plastic molded body with a proportionate film layer coating 11, wherein the foam molded body is manufactured by using tool mold 2, which is formed from a first tool cavity 21a and a second opposite tool 21b, through which the plastic molded body was produced, by applying plastic granulate 3 to the second tool cavity 21, film layer coating 11 was applied to plastic molded body 1 according to the invention.

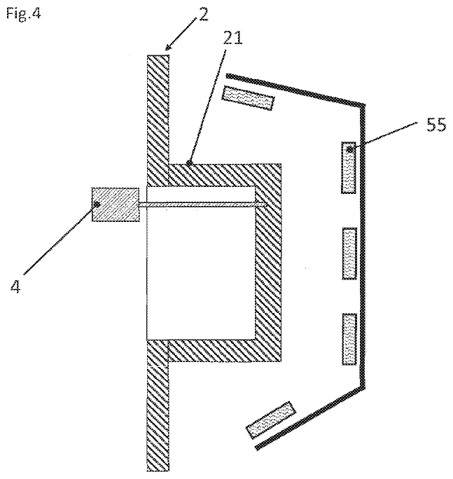

FIG. 4 shows a further exemplary embodiment of a tool cavity 21 according to the invention with a temperature sensor 4 and an external heat source 55 having the form of a plurality of radiant heaters with directional orifices. Tool cavity 21 can be heated by means of external heat source 55 to a defined temperature and sensor 4 can be used to control heat source 55.

1.-15. (canceled)

16. A method for manufacturing a foamed plastic molded body with a film layer coating by using a tool mold with at least one tool cavity to form a shaping mold cavity, comprising the following method steps:
A) heating at least one tool cavity of the tool mold;
B) applying a granulate to the at least one heated tool cavity;
C) fusing the granulate in the heated tool cavity to form a liquid film layer;
D) applying the liquid film layer to a foamed plastic molded body to form a film layer coating on the surface of the plastic molded body by fusing the liquid film layer with the surface of the plastic molded body;
E) cooling the at least one tool cavity and ejecting the plastic molded body coated with the film layer.

17. The manufacturing method according to claim 16, wherein before performing method steps A) to E), the plastic molded body is produced in the tool mold by an expansion method, then the tool mold is opened, wherein the plastic molded body remains in at least one first tool cavity and method steps A) to E) are then performed for at least one second opposite tool cavity, wherein applying the liquid film layer by fusing the liquid film layer with the surface of the plastic molded body is per-formed according to method step D) by closing the tool mold again and the cooling in method step E) of the at least one tool cavity is per-formed in the closed molding condition.

18. The manufacturing method according to claim 16, wherein in the area of the at least one tool cavity first method steps A) to C) are performed, then the tool mold is closed and the mold cavity of the tool mold is filled with a first expandable plastic granulate or with foam pearls, respectively, and then the first plastic granulate or the foam pearls, respectively, are expanded in the mold cavity, wherein method step D) is performed by the fact that the plastic molded body or the first expand-able plastic granulate or the foam pearls, respectively, is expanded against the liquid film layer formed on the at least one tool cavity and fuses therewith.

19. The manufacturing method according to claim 16, wherein the granulate is applied in method step B) beyond the region of the at least one tool cavity to the multi-part tool mold, and that at least one part of the multi-part tool mold comprises a sealing ring which, when closing the tool mold, throws up the granulate outside the region of the at least one first and/or second tool cavity to a bead in the edge area of the at one first and/or second tool cavity.

20. The manufacturing method according to claim 18, wherein in the method step of the expansion of the first expandable plastic granulate or the foam pearls, respectively, the expansion process is terminated after a defined period of time and the first plastic granulate or the foam pearls, respectively, which are not yet melted or expanded are removed from the mold cavity such that only a layer of the first expanded plastic granulate or of the foam pearls, respectively, adheres to the film layer.

21. The manufacturing method according to claim 20, wherein after removing the non-expanded proportions of the first plastic granulate or of the foam pearls, respectively, the mold cavity is filled with a second expandable plastic granulate or with foam pearls, respectively, which are then expanded to form the plastic molded body.

22. The manufacturing method according to claim 16, wherein the granulate is applied in method step B) by means of a spray pistol to the at least one tool cavity.

23. The manufacturing method according to claim 16, wherein the at least one tool cavity to be heated is heated in method step A) by introducing a heating medium through the corresponding heating channels in the at least one tool cavity.

24. The manufacturing method according to claim 16, wherein in method step A) the at least one tool cavity to be heated is heated to at least a temperature above the melting temperature of the granulate, in particular to a temperature in the range of 80° C. to 260° C.

25. The manufacturing method according to claim 16, wherein in method step B) a powdery thermoplastic plastic granulate is applied to the at least one tool cavity.

26. The manufacturing method according to claim 16, wherein the at least one tool cavity to be heated is heated in method step A) by an external heating source which is arranged to be spaced apart from the at least of tool cavity, such as in particular a radiant heater.

27. The manufacturing method according to claim 16, wherein in method step B) granulate is only proportionately applied to defined partial re-gions of the at least one tool cavity to form at least one film layer in certain areas, wherein in subregions of the at least one tool cavity can be covered in order to prevent a granulate application in method step B).

28. The manufacturing method according to claim 16, wherein in method step B) a granulate is applied to the tool cavity with a layer thickness in the range of 0.05 mm to 2 mm.

29. The manufacturing method according to claim 16, wherein in method step E) the at least one tool cavity to be cooled is cooled convectively and/or conductively.

30. The manufacturing method according to claim 18, wherein the expandable plastic granulate or the foam pearls, respectively, are supplied and/or discharged through at least one injector device.
